(19) United States
(12) Patent Application Publication
(10) Pub. No.: US 2010/0283370 A1
(43) Pub. Date: Nov. 11, 2010

(54) LIGHT-EMITTING SUBSTRATE INCLUDING LIGHT-EMITTING MEMBERS AND IMAGE DISPLAY APPARATUS INCLUDING THE LIGHT-EMITTING SUBSTRATE

(75) Inventors: Tomoya Onishi, Ayase-shi (JP); Yukihiro Inoue, Ebina-shi (JP); Tomonaga Iwahara, Atsugi-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/767,144

(22) Filed: Apr. 26, 2010

(30) Foreign Application Priority Data
May 8, 2009 (JP) 2009-113570

(51) Int. Cl. H01J 1/70

(52) U.S. Cl. 313/1

(57) ABSTRACT

A light-emitting substrate includes a substrate, a plurality of light-emitting members arranged in a matrix on the substrate, and a plurality of metal backs arranged in a matrix over the plurality of light-emitting members. In each row or each column of the plurality of metal backs, two adjacent metal backs are connected to each other through a resistive member. A conductive member having a resistance value lower than that of the resistive member is connected to a portion of the resistive member, the portion being spaced from the two adjacent metal backs.

### BACKGROUND OF THE INVENTION

1. Field of the Invention

The present invention relates to a light-emitting substrate including light-emitting members that emit light by being irradiated with electrons. The present invention also relates to an image display apparatus, such as a television, that has a display panel including the light-emitting substrate.

2. Description of the Related Art

There is a known type of image display apparatus in which light-emitting members, such as phosphor, are irradiated with electrons emitted from electron-emitting devices. The image display apparatus of this type has a display panel including a flat rectangular vacuum envelope whose internal space is maintained at a pressure (vacuum) lower than atmospheric pressure. The flat rectangular vacuum envelope typically includes a rear plate and a face plate (light-emitting substrate). The rear plate has many electron-emitting devices arranged in a matrix. The face plate has light-emitting members, such as phosphor, and metal backs serving as anode electrodes for applying a high voltage of several tens of kilovolts (kV) to the light-emitting members. The face plate and the rear plate are disposed opposite each other and joined together to form an air-tight seal at their edges, so that the flat rectangular vacuum envelope is constructed.

Japanese Patent Laid-Open No. 2006-120622 discloses an image display apparatus in which a plurality of metal backs are arranged in a matrix and electrically connected by strip resistors on a row-by-row or column-by-column basis. Thus, even if a discharge occurs between electron-emitting devices and the metal backs, it is possible to reduce damage to the electron-emitting devices.

In the image display apparatus described in Japanese Patent Laid-Open No. 2006-120622, if, for example, a discharge (short circuit) occurs between the electron-emitting devices and any one of the metal backs, the potential of this metal back momentarily drops. As a result, a large potential difference (i.e., a large electric field) momentarily develops between this metal back and another metal back adjacent thereto. To reduce a flow of current (discharge current) produced by momentary development of such a potential difference, it is necessary that a resistor that connects two adjacent metal backs have a high resistance value. At the same time, it is necessary that the resistor have a low resistance value. Specifically, metal backs are irradiated with electrons when the image display apparatus is being driven. Since this causes a drop in potential of the metal backs, the resistor needs to have a low resistance value to reduce such a drop.

In recent years, however, there have been demands for image display apparatuses having higher light-emitting luminance and capable of providing higher-resolution display images.

To improve light-emitting luminance of an image display apparatus, it is necessary to apply a higher potential to metal backs and increase the number of electrons emitted from electron-emitting devices.

To provide higher-resolution display images, it is necessary to reduce an area where resistors are to be arranged and a cross-sectional area allowed for the resistors. This results in an increased resistance value of the resistors.

In such a case, to reduce the discharge current and the drop in potential of the metal backs as described above, a distance between two adjacent metal backs may be reduced. However, when a discharge occurs, a small distance between metal backs may lead to an increased potential difference (electric field) between two adjacent metal backs connected to each other by a resistor. As a result, withstand voltage performance of the resistor may be degraded.

In other words, when a discharge occurs, two metal backs adjacent to each other through a resistor are electrically short-circuited. This increases a discharge current flowing through an electron-emitting device and may damage the electron-emitting device.

Accordingly, there is a demand for realizing a high-resolution high-luminance image display apparatus capable of exhibiting high withstand voltage performance when a discharge occurs, and reducing a drop in voltage of metal backs when the image display apparatus is being driven.

### SUMMARY OF THE INVENTION

The present invention provides a light-emitting substrate including a substrate, a plurality of light-emitting members arranged in a matrix on the substrate, and a plurality of metal backs arranged in a matrix over the plurality of light-emitting members. In each row or each column of the plurality of metal backs, two adjacent metal backs are connected to each other through a resistive member. A conductive member having a resistance value lower than that of the resistive member is connected to a portion of the resistive member, the portion being spaced from the two adjacent metal backs.

According to an embodiment of the present invention, even if an intense electric field is applied to the resistive member through which two adjacent metal backs are connected to each other, the resistive member can maintain its function and prevent the image display apparatus from being seriously damaged. At the same time, it is possible to easily control an effective resistance value of the resistive member.

Further features of the present invention will become apparent from the following description of embodiments with reference to the attached drawings.

### BRIEF DESCRIPTION OF THE DRAWINGS

FIG. 1A to FIG. 1C illustrate a light-emitting substrate according to an embodiment of the present invention.

FIG. 2A and FIG. 2B illustrate a configuration of an image display apparatus.

FIG. 3A and FIG. 3B are schematic diagrams illustrating a change in flow of electrons depending on whether there is a conductive member, FIG. 3C is a graph schematically showing how the withstand field strength of a resistive member is dependent on the length of the resistive member, and FIG. 3D is a graph schematically showing how the withstand field strength of the resistive member is dependent on the volume resistivity of the resistive member.

FIG. 4A to FIG. 4I illustrate exemplary arrangements of the conductive member.

FIG. 5A and FIG. 5B illustrate other exemplary arrangements of the conductive member.

FIG. 6 illustrates a light-emitting substrate according to another embodiment of the present invention.

### DESCRIPTION OF THE EMBODIMENTS

The present invention is applicable to a field-emission display (FED) in which electrons emitted from electron-emitting devices are accelerated by metal backs to which a high voltage is applied, so that the accelerated electrons are smashed into light-emitting members (e.g., phosphor) and light is emitted. Examples of the electron-emitting devices include cold cathodes, such as field emission type electron-emitting devices, surface-conduction electron-emitting devices, metal-insulator-metal (MIM) type electron-emitting devices, or ballistic electron surface-emitting devices (BSDs).

Hereinafter, a display panel including electron-emitting devices that emit electrons by applying a voltage between a cathode electrode and a gate electrode will be described as an example.

The display panel refers to a so-called display module. The display panel of the present embodiment includes a vacuum envelope 100. An image display apparatus refers to an apparatus including the display panel, a receiver that receives an image signal (e.g., television signal) input from the outside, an image processing circuit that performs predetermined processing on the input image signal in accordance with characteristics of the display panel, and a speaker. A typical example of the image display apparatus is a television apparatus.

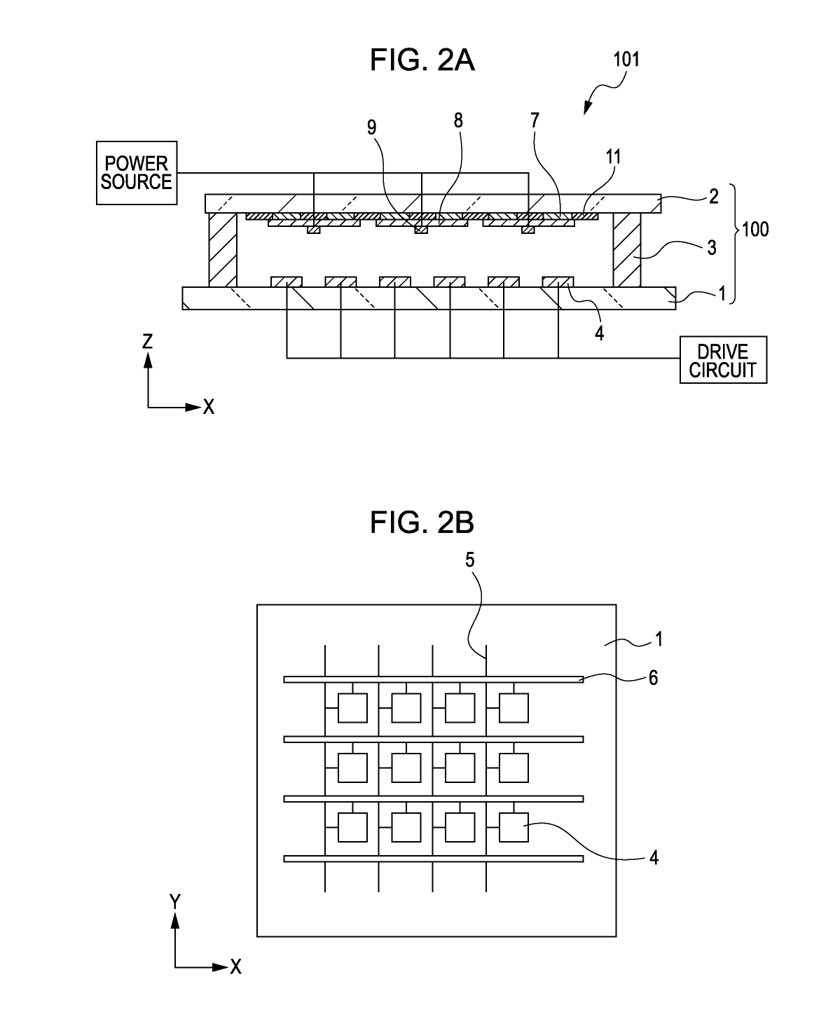

An overview of a display panel 101 included in the image display apparatus will be described with reference to FIG. 2A and FIG. 2B. FIG. 2A is a schematic cross-sectional view of the display panel 101. FIG. 2B is a schematic plan view illustrating a rear substrate 1 as viewed from a front substrate 2.

The display panel 101 includes the vacuum envelope 100, whose internal space is maintained at a vacuum of about 10⁻⁴ Pa or less (i.e., at a pressure lower than atmospheric pressure). The vacuum envelope 100 includes a plurality of electron-emitting devices 4, a plurality of light-emitting members 7 (e.g., phosphor) corresponding to the respective electron-emitting devices 4, and a plurality of metal backs 8 serving as anode electrodes. The rear substrate 1 and the front substrate 2 that is transparent to visible light are disposed opposite each other, with a 1-mm to 2-mm gap created by a support frame 3 therebetween. The front substrate 2 and the rear substrate 1 are joined together to form an air-tight seal at their edges, so that the vacuum envelope 100 with a flat rectangular shape is constructed. The thicknesses of the front substrate 2 and the rear substrate 1 are each from 0.5 mm to 3 mm, and preferably 1 mm or less. To support the vacuum envelope 100 against atmospheric pressure that acts on the rear substrate 1 and the front substrate 2, many spacers (not shown) may be provided between these substrates. Examples of such a display panel include an FED.

As illustrated in FIG. 2B, the plurality of electron-emitting devices 4 are arranged in a matrix on the rear substrate 1. The electron-emitting devices 4 each are connected to any one of a plurality of scanning lines 6 and any one of a plurality of signal lines 5. A drive circuit (see FIG. 2A) that drives each of the electron-emitting devices 4 is connected to the electron-emitting devices 4 through the signal lines 5 and the scanning lines 6. The arrangement and structure of the electron-emitting devices 4 and the lines 5 and 6, and methods for manufacturing them will not be described in detail here, as publicly known techniques can be appropriately adopted. Examples of the electron-emitting devices 4 include surface-conduction electron-emitting devices and field emission type electron-emitting devices.

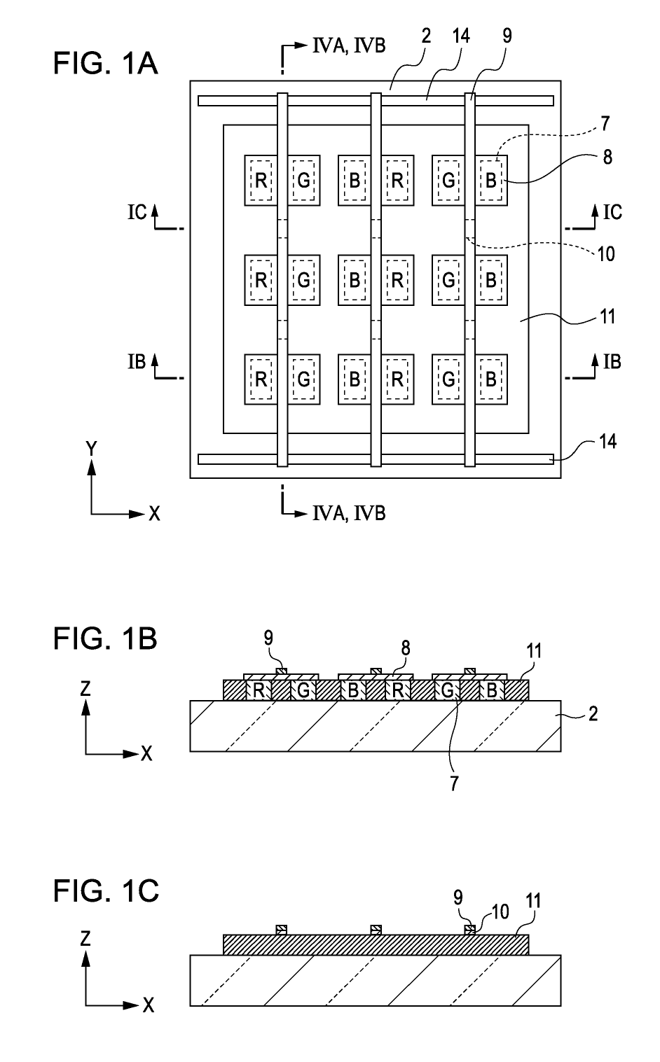

A light-emitting substrate (face plate) is produced by arranging the plurality of light-emitting members 7 and the plurality of metal backs 8 on the front substrate 2 which has an optical characteristic of being transparent to visible light. For example, a glass substrate can be used as the front substrate 2. FIG. 1A is a schematic plan view illustrating the front substrate 2 as viewed from the rear substrate 1. FIG. 1B is a cross-sectional view taken along line IB-IB of FIG. 1A. FIG. 1C is a cross-sectional view taken along line IC-IC of FIG. 1A. In FIG. 1A to FIG. 1C and FIG. 2A and FIG. 2B, the same reference numerals designate the same components. As illustrated in FIG. 2A, the metal backs 8 are disposed on one side of the light-emitting members 7, the one side being adjacent to the rear substrate 1. The plurality of metal backs 8 each are disposed over a plurality of light-emitting members 7 such that all the plurality of light-emitting members 7 are covered with the metal backs 8.

To produce the metal backs 8 separately arranged, a metal back is first formed by evaporation or the like over a region where the light-emitting members 7 are formed on the front substrate 2 by a typical method. Then, the resulting metal back is patterned by photo-etching to produce the metal backs 8. Alternatively, for example, a metal mask having desired openings may be used as a shielding member to perform evaporation (generally referred to as mask evaporation). Aluminum is often used as a material of metal backs. Therefore, metal backs can be generally regarded as a metal film of aluminum.

On a principal surface of the front substrate 2, the principal surface facing the rear substrate 1, the plurality of light-emitting members 7 are arranged in a matrix in an X direction (hereinafter referred to as a first direction) and a Y direction (hereinafter referred to as a second direction) orthogonal to the X direction. Each of the light-emitting members 7 emits, for example, red (R), green (G), or blue (B) light when irradiated with electrons. Here, the light-emitting members 7 for red, green, and blue colors are repeatedly arranged in this order along the first direction. At the same time, the light-emitting members 7 for the same color are arranged along the second direction. To prevent beams of light emitted from the light-emitting members 7 from interfering with each other, a shielding member 11 of black material can be provided between adjacent light-emitting members 7. In other words, the shielding member 11 can be provided with a plurality of openings arranged in a matrix, and the plurality of light-emitting members 7 can be positioned at their corresponding openings. The shielding member 11 serves as a so-called black matrix.

The plurality of metal backs 8 are also arranged in a matrix in the first direction and the second direction over the light-emitting members 7. Specifically, each row of the plurality of metal backs 8 includes “m” metal backs 8 arranged in the first direction and each column of the plurality of metal backs 8 includes “n” metal backs 8 arranged in the second direction, where both “m” and “n” are integers greater than or equal to two. The number of metal backs 8 in each column extending in the second direction “n” is smaller than or equal to the number of light-emitting members 7 in each column extending in the second direction. The number of metal backs 8 in each row extending in the first direction “m” is smaller than the number of light-emitting members 7 in each row extending in the first direction.

In the example of FIG. 1A, two light-emitting members 7 adjacent in the first direction are covered with one metal back 8. Although covering one light-emitting member 7 with one metal back 8 can minimize damage caused by discharge, it may be difficult to realize this configuration by patterning. Therefore, by considering the display area of the image display apparatus (i.e., the total area of the light-emitting members 7) and a discharge current generated when a discharge occurs, the number of metal backs 8 (or the number of light-emitting members 7 covered with one metal back 8) can be appropriately set. For example, three light-emitting members 7 (RGB) adjacent in the first direction may be covered with one metal back 8. Alternatively, for example, four light-emitting members 7 adjacent in both the first and second directions (i.e., two light-emitting members 7 adjacent in the first direction and two light-emitting members 7 adjacent in the second direction) may be covered with one metal back 8.

In each column of metal backs 8 (i.e., each column extending in the second direction), two adjacent metal backs 8 are connected to each other through a resistive member 9 extending in the second direction. The resistive member 9 is disposed such that it is not positioned directly above the light-emitting members 7. The resistive member 9 can be made of high-resistance metal oxide, such as ruthenium oxide, indium tin oxide (ITO, a compound of indium oxide and tin oxide), or antimony tin oxide (ATO, antimony-added tin oxide). By applying and baking high-resistance paste produced by mixing such metal oxide with glass frit, it is possible to form the resistive member 9 having desired electrical characteristics. The resistive member 9 may be made of high-resistance amorphous silicon. The sheet resistance of the resistive member 9 is practically set to a value from 1.0×10³ Ω/□ to 1.0×10⁶ Ω/□, preferably set to a value from 1.0×10⁴ Ω/□ to 1.0×10⁵ Ω/□, and more preferably set to a value from 5.0×10⁴ Ω/□ to 1.5×10⁵ Ω/□. The volume resistivity of the resistive member 9 is practically set to a value from 1.0×10⁻¹ Ω·m to 1.0×10¹ Ω·m, and preferably set to a value from 5.0×10⁻¹ Ω·m to 2.0 Ω·m. Since the metal backs 8 are actually metal films, the sheet resistance and volume resistivity of the metal backs 8 are at least two orders of magnitude (practically at least five orders of magnitude) lower than those of the resistive member 9.

In the example of FIG. 1A, in one column of metal backs 8 arranged in the second direction, one resistive member 9 extending in a straight line connects all three or more metal backs 8 arranged in the second direction in series. However, one resistive member 9 may be provided for every two metal backs 8 adjacent in the second direction. The number of resistive members 9 that connect two metal backs 8 adjacent in the second direction can be appropriately set. When a plurality of resistive members 9 are used for each column of metal backs 8, the plurality of resistive members 9 can be arranged in a line along the second direction. Alternatively, in each column of metal backs 8, two metal backs 8 adjacent in the second direction may be connected through a plurality of resistive members 9 extending in the second direction. In this case, in each column of metal backs 8, a plurality of resistive members 9 can be arranged both in a line and in a plurality of lines.

In the example of FIG. 1A, a plurality of metal backs 8 in each column are connected by one resistive member 9. In contrast to this, a plurality of metal backs 8 in each row may be connected by one resistive member 9. However, when the direction in which the scanning lines 6 extend (i.e., X direction in FIG. 2B) and the direction in which a plurality of metal backs 8 are connected by the resistive member 9 cross each other (or are orthogonal to each other), it is possible to limit a discharge current and reduce damage caused by discharge.

The resistive members 9 serve as wiring for supplying a high voltage (anode voltage) from low-resistance common electrodes 14 to the metal backs 8, the common electrodes 14 including wiring made mainly of silver. The resistive members 9 also serve as resistors that limit a discharge current using a current limiting effect.

The common electrodes 14 are electrically connected to anode terminals provided outside the display panel 101 and connected to a power source (see FIG. 2A). The power source supplies a constant high voltage (e.g., several tens of kilovolts (kV)) through the resistive members 9 to the plurality of metal backs 8 serving as anode electrodes. A configuration of connection between the anode terminals and the common electrodes 14 will not be described here, as a publicly known configuration is adoptable here.

The resistive members 9 are capable of limiting a current that flows when a discharge occurs. However, if a discharge causes a large potential difference (electric field) to develop between two metal backs 8 adjacent in the second direction, withstand voltage performance of the resistive members 9 may be degraded and a large current may flow, as described above.

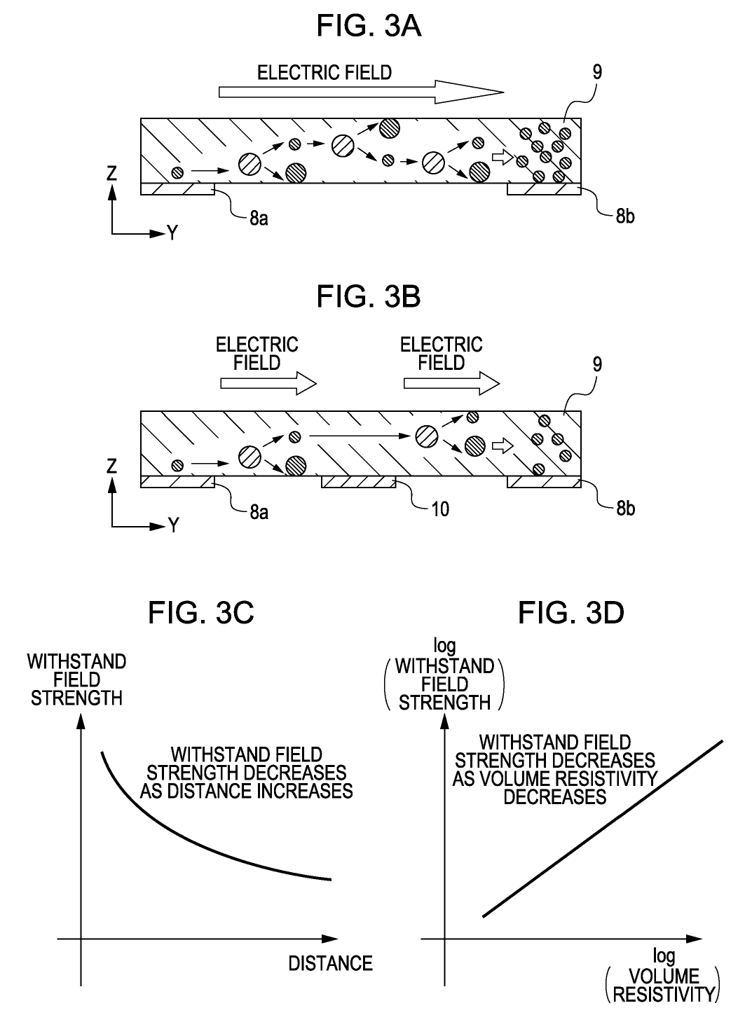

With reference to FIG. 3A and FIG. 3B, a description will be given about an assumed mechanism in which withstand voltage capability of a resistive member 9 is degraded when a large potential difference develops between adjacent metal backs 8, and also about an effect of the present invention. FIG. 3A and FIG. 3B are schematic cross-sectional views of portions where two metal backs 8a and 8b adjacent in the second direction are connected to each other through the resistive member 9.

When a potential of the metal back 8a abruptly drops below that of the metal back 8b (i.e., at the time of discharge), an electric field directed from the metal back 8a to the metal back 8b is abruptly generated. In the resistive member 9, electrons are accelerated by the generated electric field and smashed into atoms, so that a plurality of electrons are emitted as free electrons. This process occurs repeatedly. Then, generated electrons cause an electron avalanche, so that a large current is assumed to flow between the metal backs 8a and 8b. When a potential applied to the metal backs 8a and 8b is constant, an electric field generated at the time of discharge is expected to increase as a distance between the two metal backs 8a and 8b decreases, or as a cross-sectional area of the resistive member 9 decreases (i.e., as a resistance value of the resistive member 9 increases).

FIG. 3C is a graph schematically showing how the withstand field strength of the resistive member 9 is dependent on the length of the resistive member 9. In the graph, the horizontal axis represents the length of the resistive member 9 (i.e., a distance between adjacent metal backs 8), and the vertical axis represents the withstand field strength of the resistive member 9. As can be seen from FIG. 3C, as the length of the resistive member 9 decreases, the withstand field strength improves and the degree of contribution to the improved withstand field strength (negative inclination) becomes larger. This tendency is common to high-resistance materials, such as the materials described above.

As illustrated in FIG. 3B, when a conductive member 10 is connected to a portion of the resistive member 9 that connects the two metal backs 8a and 8b adjacent in the second direction, a region where electrons are not accelerated can be created in the portion of the resistive member 9 (i.e., the portion where the conductive member 10 is provided). As a result, the withstand field strength between the two metal backs 8a and 8b adjacent in the second direction in the configuration of FIG. 3B becomes larger than that in the configuration of FIG. 3A. This is based on the assumption that the distance between the metal backs 8a and 8b in FIG. 3A is the same as the sum of the distance between the metal back 8a and the conductive member 10 and the distance between the metal back 8b and the conductive member 10 in FIG. 3B.

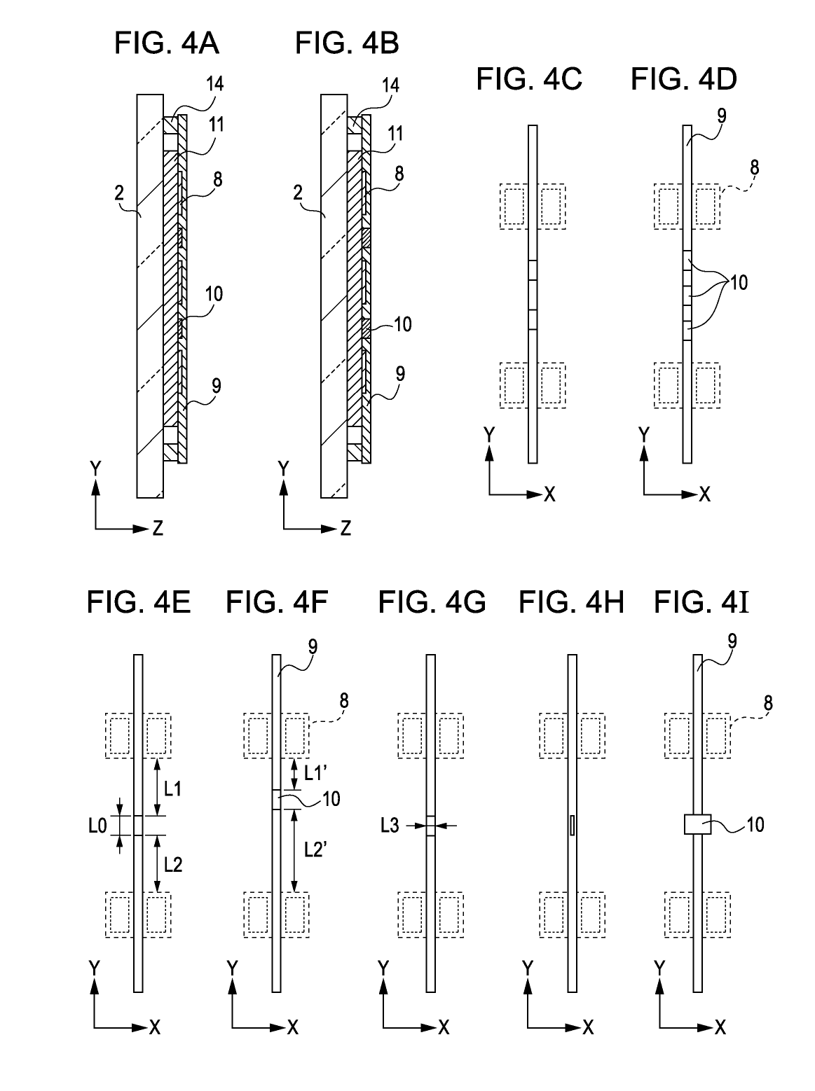

Exemplary arrangements of the conductive member 10 are illustrated in FIG. 4A and FIG. 4B, which are cross-sectional views taken along line IVA-IVA (IVB-IVB) of FIG. 1A.

As illustrated in FIG. 4A, when the resistive member 9 is disposed over the conductive member 10, the resistive member 9 and the conductive member 10 can be directly connected to each other. In the configuration of FIG. 4A, the resistive member 9 has a first portion close to one of two metal backs 8 adjacent in the second direction, a second portion close to the other of the two metal backs 8, and a third portion between the first and second portions. In this configuration, the conductive member 10 can be directly connected to the third portion of the resistive member 9.

As illustrated in FIG. 4B, the resistive member 9 may have a plurality of portions which are connected to each other by the conductive member 10 therebetween. Specifically, in the configuration of FIG. 4B, the resistive member 9 has a first portion close to one of two metal backs 8 adjacent in the second direction and a second portion close to the other of the two metal backs 8. The conductive member 10 is disposed between the first portion and the second portion, and connected to both the first portion and the second portion.

In the configuration of FIG. 4A, the conductive member 10 is disposed between the resistive member 9 and the front substrate 2 (i.e., more specifically, between the resistive member 9 and the shielding member 11). Alternatively, the conductive member 10 may be disposed on the resistive member 9 (i.e., on the side remote from the shielding member 11). Similarly, the metal backs 8 may also be disposed on the resistive member 9 (i.e., on the side remote from the shielding member 11). In other words, the resistive member 9 may be disposed between the metal backs 8 and the front substrate 2 (i.e., more specifically, between the metal backs 8 and the shielding member 11) and/or between the conductive member 10 and the front substrate 2 (i.e., more specifically, between the conductive member 10 and the shielding member 11).

As illustrated in FIG. 4C and FIG. 4D, the conductive member 10 may be provided in a plurality between two metal backs 8 adjacent in the second direction. FIG. 4C and FIG. 4D are partial schematic plan views each illustrating the front substrate 2 as viewed from the rear substrate 1, as in the case of FIG. 1A. FIG. 4C illustrates a configuration in which two conductive members 10 are provided between two metal backs 8 adjacent in the second direction. FIG. 4D illustrates a configuration in which three conductive members 10 are provided between two metal backs 8 adjacent in the second direction. As illustrated in FIG. 4C and FIG. 4D, the plurality of conductive members 10 between the two metal backs 8 adjacent in the second direction are spaced apart by a predetermined distance.

As illustrated in FIG. 4E and FIG. 4F, as long as the conductive member 10 is spaced from both of two metal backs 8 adjacent in the second direction, it is possible to improve the withstand field strength described above. As illustrated in FIG. 4E, the conductive member 10 can be located at a position that equally divides the distance between the two adjacent metal backs 8. In other words, the conductive member 10 can be placed such that the relationship L1=L2 is satisfied. This relationship also applies to the configuration in which the conductive member 10 is provided in a plurality. In the case of the relationship L1′≢L2′ illustrated in FIG. 4F, the withstand field strength may be defined by the longer portion indicated by L2′. When the conductive member 10 is provided in a plurality between the two metal backs 8 adjacent in the second direction, the conductive members 10 can be evenly spaced apart.

A length (L0) of the conductive member 10 in the second direction (Y direction) can be appropriately determined in accordance with the resistance value and withstand field strength necessary for a portion between the metal backs 8. To provide the above-described effect of the conductive member 10, practically, the length of the conductive member 10 can be greater than or equal to the thickness of the resistive member 9. In other words, practically, the conductive member 10 can be connected to the resistive member 9 over a length greater than or equal to the thickness of the resistive member 9 in the second direction (i.e., in the longitudinal direction of the resistive member 9).

As illustrated in FIG. 4G, FIG. 4H, and FIG. 4I, a width (L3) of the conductive member 10 may be the same as that of the resistive member 9 (see FIG. 4G), smaller than that of the resistive member 9 (see FIG. 4H), or greater than that of the resistive member 9 (see FIG. 4I).

The resistance value of the conductive member 10 may be any value, as long as it is a desired value in a region in contact with the resistive member 9. The volume resistivity, thickness, and width of the conductive member 10 are appropriately selected depending on the application. To provide the above-described effect of the conductive member 10, practically, the conductive member 10 can have a resistance value at least one order of magnitude lower than that of the resistive member 9.

A simple way of forming the conductive member 10 is to form the conductive member 10 simultaneously with formation of the metal backs 8. As a result, electrical characteristics (e.g., sheet resistance and volume resistivity) of the conductive member 10 can be made similar to those of the metal backs 8. Thus, like the metal backs 8, the conductive member 10 can be regarded as a metal film.

The material of the conductive member 10 may either be the same as or different from that of the metal backs 8. The material of the conductive member 10 can be appropriately selected from metal materials, such as aluminum (Al), copper (Cu), titanium (Ti), silver (Ag), gold (Au), molybdenum (Mo), tungsten (W), tantalum (Ta), platinum (Pt), and nickel (Ni), by considering the volume resistivity and manufacturing processes.

FIG. 3D is a graph schematically showing how the withstand field strength of the resistive member 9 is dependent on the volume resistivity of the resistive member 9. In the graph, the horizontal axis represents the volume resistivity of the resistive member 9 (in logarithmic expression) and the vertical axis represents the withstand field strength of the resistive member 9 (in logarithmic expression). As can be seen from FIG. 3D, the withstand field strength of the resistive member 9 improves as the volume resistivity of the resistive member 9 increases. This tendency is common to high-resistance materials, such as the materials described above.

As described above, connecting the conductive member 10 to the resistive member 9 makes it possible to change a resistance value between two adjacent metal backs 8 without changing the volume resistivity of the resistive member 9 (i.e., without changing the withstand field strength of the resistive member 9). In other words, while maintaining the withstand field strength of the resistive member 9 at a high level, it is possible to control an effective resistance value of metal backs 8 connected in series through the resistive member 9 in each column. Thus, even when the resistance value of the metal backs 8 in each column is adjusted to a desired level, it is possible to maintain the withstand field strength of the resistive member 9 while maintaining the volume resistivity of the resistive member 9.

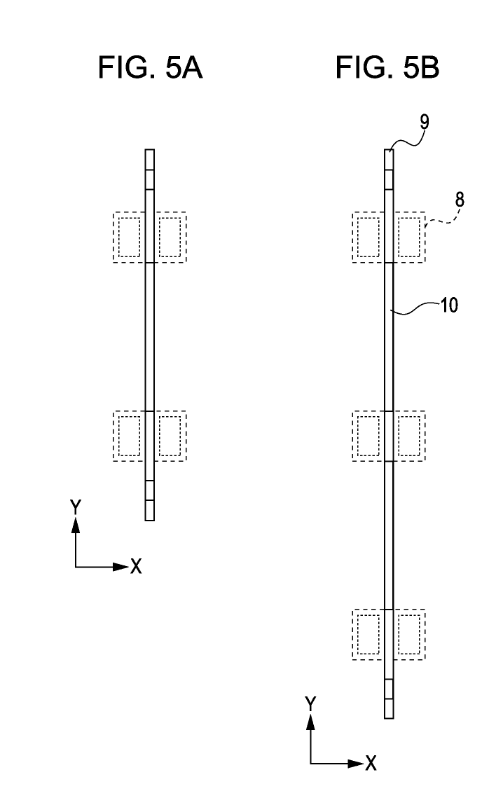

Specifically, as illustrated in FIG. 5A, when metal backs 8 in one or more pairs of metal backs 8 adjacent in the second direction are electrically and physically connected by the conductive member 10, it is possible to change the resistance value of metal backs 8 in each column without changing the volume resistivity of the resistive member 9. As described above, the conductive member 10 can be formed simultaneously with formation of metal backs 8. Therefore, without separating and simply by connecting metal backs 8 in one or more pairs of metal backs 8 adjacent in the second direction, it is possible to change the resistance value of metal backs 8 in each column.

When two metal backs 8 adjacent in the second direction are connected by the conductive member 10 therebetween, it is also possible to connect three or more metal backs 8 adjacent in the second direction. FIG. 5B illustrates a configuration in which three metal backs 8 adjacent in the second direction are continuously connected. The number of metal backs 8 to be continuously connected can be determined such that the resistive member 9 for each column of metal backs 8 has a desired resistance value.

Thus, it is possible to achieve both reducing a resistance value of metal backs 8 in each column (i.e., reducing a voltage drop when the image display apparatus is being driven) and maintaining the volume resistivity and withstand field strength of the resistive member 9.

As illustrated in FIG. 1A to FIG. 1C, spaces between adjacent light-emitting members 7 can be filled with the shielding member (black matrix) 11.

In this case, the shielding member 11 electrically connects two metal backs 8 adjacent in the first direction. For the purpose of limiting a discharge current, it is only necessary that the resistance of the shielding member 11 be at least two orders of magnitude higher than that of the resistive member 9. Practically, the sheet resistance of the shielding member 11 between two metal backs 8 adjacent in the first direction can be set to a value from 1.0×10⁶ Ω/□ to 1.0×10⁹ Ω/□. The shielding member 11 can be made of, for example, material mainly composed of graphite normally used as a material of a black matrix, or material having low optical transmittance and reflectance.

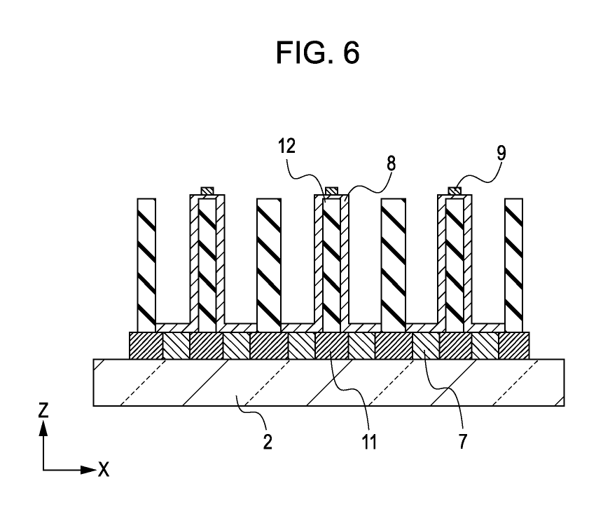

FIG. 6 is a schematic cross-sectional view of a light-emitting substrate according to another embodiment of the present invention. As illustrated in FIG. 6, the light-emitting substrate can be provided with partition members (ribs) 12. The partition members 12 are located between light-emitting members 7 adjacent in the first direction, extend in the second direction, and protrude toward the rear substrate 1. The partition members 12 can be made of insulating material. For example, the partition members 12 can be formed by placing photosensitive insulating paste on the shielding member 11, exposing it to light, and developing and baking it.

The partition members 12 are provided to prevent a phenomenon (halation) in which wrong neighboring light-emitting members 7 are irradiated with recoil electrons and emit light. The recoil electrons are generated when electrons emitted from the electron-emitting devices 4 are partially reflected by the metal backs 8 etc. to the rear substrate 1.

When the partition members 12 are used, the resistive members 9 can be arranged to extend in the second direction on the surfaces (upper surfaces) of the partition members 12, the surfaces being adjacent to the rear substrate 1. For electrical connection with the resistive members 9, the metal backs 8 are arranged continuously from the upper surfaces of the light-emitting members 7, along the side surfaces of the partition members 12, to the upper surfaces of the partition members 12.

It is necessary that the partition member 12 satisfy electrical characteristics similar to those of the shielding member 11. Specifically, it is only necessary that the resistance of the partition member 12 be at least two orders of magnitude higher than that of the resistive member 9. Practically, the sheet resistance of the partition member 12 between two metal backs 8 adjacent in the first direction can be set to a value from 1.0×10⁶ Ω/□ to 1.0×10⁹ Ω/□.

### EMBODIMENTS

Specific embodiments of the present invention will now be described. A description of how the rear substrate 1 and the support frame 3 are produced will not be given here. For example, the rear substrate 1 and the support frame 3 are produced as described in Japanese Patent Laid-Open Nos. 2-56822 and 2000-251708. The following description refers to a light-emitting substrate (face plate).

### FIRST EMBODIMENT

A method for producing a light-emitting substrate (face plate) according to a first embodiment of the present invention will be described with reference to FIG. 1A to FIG. 1C.

A glass substrate (such as PD-200 produced by Asahi Glass Co., Ltd.) is used as the front substrate 2. After the front substrate (glass substrate) 2 is cleaned, the shielding member 11 is formed on the principal surface of the front substrate 2. As a material of the shielding member 11, a film of black paste (such as NP-7803D produced by Noritake Co., Limited) is formed on the principal surface of the front substrate 2 by screen printing. The resulting film has a matrix of openings corresponding to the plurality of light-emitting members 7. The openings are arranged at a 150-μm pitch in the first direction and at a 450-μm pitch in the second direction. The size of each opening is 90 μm in the first direction and 220 μm in the second direction. After being dried at 120° C., the film of black paste is baked at 550° C. to form the shielding member 11 having a thickness of 5 μm. The resulting distance between two openings adjacent in the second direction is 230 μm.

Next, the light-emitting members 7 are formed by printing. Specifically, three-color (RGB) P22 phosphor for color display is dispersed into different polymer solvents, so that a paste for each color is prepared. The three-color phosphor pastes are screen-printed in stripes in the second direction such that they are aligned with the openings of the shielding member 11. The light-emitting members 7 have a thickness of 15 μm and are dried at 120° C.

To reduce variations in distances between, and heights of, the phosphor particles constituting the light-emitting members 7, aqueous solution of acrylic emulsion is applied as filming solution to the principal surface of the front substrate 2 by spray coating. The applied solution is dried into a filming layer on the light-emitting members 7. Next, an aluminum film is evaporated onto the filming layer by using a metal mask having a plurality of openings arranged such that each opening is positioned over two light-emitting members 7 adjacent in the first direction. Then, the filming layer is thermally decomposed and removed by baking. Thus, a plurality of metal backs 8, each being a 100-nm thick aluminum film, are formed. The metal backs 8 are formed such that two light-emitting members 7 adjacent in the first direction (e.g., RG, BR, and GB) are covered with one metal back 8. Note that two light-emitting members 7 adjacent in the second direction are not covered with one metal back 8. In other words, two light-emitting members 7 adjacent in the second direction are covered with different metal backs 8. In the second direction, each metal back 8 covering two light-emitting members 7 extends 15 μm beyond the edges of the light-emitting members 7 (i.e., the edges of the openings).

Additionally, the conductive member 10 is formed on the shielding member 11 between two metal backs 8 adjacent in the second direction. In the process of forming a layer of the metal backs 8, each of the conductive members 10 is formed to be spaced 50 μm from each of the two metal backs 8 adjacent in the second direction. This means that the conductive member 10 is 100 μm in length in the second direction. Specifically, in the metal mask described above, openings for arrangement of the conductive members 10 are created in advance. With this metal mask, the conductive members 10 of the same material and same thickness as those of the metal backs 8 are formed.

Next, with a dispenser, the resistive members 9 are formed over the metal backs 8 and the conductive members 10 alternately and repeatedly arranged in the second direction. Each resistive member 9 passes between two light-emitting members 7 adjacent in the first direction, and linearly extends in the second direction. In the present embodiment, in a region between two metal backs 8 adjacent in the second direction, the total length where the resistive member 9 acts as a resistor is 100 μm in the second direction. High-resistance paste containing ruthenium oxide is used as a material of the resistive member 9. The high-resistance paste is formed into a 5-μm thick film and dried at 120° C. Besides the ruthenium oxide described above, high-resistance metal oxide, such as ITO or ATO, can be used as a resistance adjusting component contained in the high-resistance paste. Paste produced by mixing such metal oxide with glass frit can be used as the high-resistance paste. High-resistance amorphous silicon may be used to form the resistive member 9. When the high-resistance paste was formed on a glass substrate into a pattern having a thickness of 5 μm, dried at 120° C., and measured, the volume resistivity of the high-resistance paste was about 0.5 Ω·m.

The face plate produced as described above is placed opposite a rear plate in which a plurality of surface-conduction electron-emitting devices are arranged in a matrix on the rear substrate 1. The support frame 3 is placed between the face plate and the rear plate. In a vacuum chamber maintained at 10⁻⁵ Pa, the display panel 101 is produced by sealing and bonding the rear substrate 1 and the front substrate 2 with the support frame 3 interposed therebetween.

In the display panel 101 of the present embodiment, when a voltage applied through the resistive member 9 to each of the metal backs 8 was increased by increasing an anode voltage supplied to the common electrodes 14, a phenomenon that appeared to be a discharge was not observed until 12 kV was reached. The withstand field strength of the resistive member 9 was evaluated to be about 8.5 V/μm. Measurement of resistance of the resistive member 9 showed that the resistance value and the volume resistivity of the resistive member 9 were about 170 kΩ and 0.5 Ω·m, respectively.

### FIRST COMPARATIVE EXAMPLE

In this comparative example, a light-emitting substrate and a display panel are produced in the same manner as that of the first embodiment, except that no conductive member 10 is provided and a distance between two metal backs 8 adjacent in the second direction is 100 μm. Therefore, in this comparative example, in the region between two metal backs 8 adjacent in the second direction, the length where the resistive member 9 acts as a resistor is 100 μm in the second direction. In the display panel produced in this comparative example, when a voltage applied through the resistive member 9 to each of the metal backs 8 was increased by increasing an anode voltage supplied to the common electrodes 14, a discharge occurred at 10 kV. The withstand field strength of the resistive member 9 was evaluated to be from 4 V/μm to 6 V/μm. Measurement of resistance of the resistive member 9 showed that the resistance value and the volume resistivity of the resistive member 9 were about 170 kΩ and 0.5 Ω·m, respectively.

### SECOND EMBODIMENT

A second embodiment differs from the first embodiment in terms of the volume resistivity of the resistive member 9 and the number of conductive members 10. Methods for producing the other parts will not be described here, as they are the same as those in the first embodiment.

In the second embodiment, the resistive member 9 having a volume resistivity lower than that in the first embodiment is used. In the first embodiment, one conductive member 10 is provided between two metal backs 8 adjacent in the second direction. In the second embodiment, as illustrated in FIG. 4C, two conductive members 10 are provided between two metal backs 8 adjacent in the second direction. The shortest distance between each conductive member 10 and its adjacent metal back 8 is 50 μm. The length of each conductive member 10 in the second direction is 25 μm. The distance between two conductive members 10 is 50 μm. Therefore, in the second embodiment, in the region between two metal backs 8 adjacent in the second direction, the total length where the resistive member 9 acts as a resistor is 150 μm in the second direction.

As for the other aspects, the display panel 101 is produced in the same manner as that of the first embodiment. In the display panel 101 of the present embodiment, when a voltage applied through the resistive member 9 to each of the metal backs 8 was increased by increasing an anode voltage supplied to the common electrodes 14, no discharge occurred until 12 kV was reached. The withstand field strength of the resistive member 9 was evaluated to be about 10.2 V/μm. Measurement of resistance of the resistive member 9 showed that the resistance value and the volume resistivity of the resistive member 9 were about 150 kΩ and 0.3 Ω·m, respectively. Thus, even when the resistive member 9 having a low volume resistivity and assumed to have a low withstand field strength is used, it is possible to improve the withstand field strength by providing the conductive members 10.

### THIRD EMBODIMENT

A third embodiment differs from the first embodiment in terms of the volume resistivity of the resistive member 9 and the arrangement of the conductive members 10. Methods for producing the other parts will not be described here, as they are the same as those in the first embodiment.

In the third embodiment, the resistive member 9 having a volume resistivity higher than that in the first embodiment is used. In the first embodiment, one conductive member 10 is provided between two metal backs 8 adjacent in the second direction. In the third embodiment, as illustrated in FIG. 5A, in each column of metal backs 8 arranged in the second direction, metal backs 8 in one or more pairs of metal backs 8 adjacent in the second direction are electrically connected by the conductive member 10. Here, in each column of metal backs 8 of the first embodiment, the odd-numbered (N-th) and even-numbered ((N+1)-th) metal backs 8, such as the first and second metal backs 8, the third and fourth metal backs 8, and the fifth and sixth metal backs 8 arranged in this order from the top, are connected by the conductive member 10. As in the case of the first embodiment, all metal backs 8 in each column are connected by one linear resistive member 9.

At the same time, between two metal backs 8 adjacent in the second direction but not electrically connected by any conductive member 10, one conductive member 10 is placed, as in the case of the first embodiment. That is, one conductive member 10 is placed between the (N+1)-th and (N+2)-th metal backs 8, such as between the second and third metal backs 8 and between the fourth and fifth metal backs 8.

As for the other aspects, the display panel 101 is produced in the same manner as that of the first embodiment. In the display panel 101 of the present embodiment, when a voltage applied through the resistive member 9 to each of the metal backs 8 was increased by increasing an anode voltage supplied to the common electrodes 14, no discharge occurred until 12 kV was reached. The withstand field strength of two continuous resistive members 9 that connect the N-th, (N+1)-th, and (N+2)-th metal backs 8 was evaluated to be 8.5 V/μm. Measurement of the resistance of the resistive members 9 showed that the resistance value and volume resistivity of the resistive members 9 were about 170 kΩ and 1.0 Ω·m, respectively. Thus, even when the resistive members 9 having a high volume resistivity and considered to have high withstand field strength are used, it is possible to reduce the withstand field strength by providing the conductive members 10.

### OTHER EMBODIMENTS

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to embodiments, it is to be understood that the invention is not limited to the disclosed embodiments.

This application claims the benefit of Japanese Patent Application No. 2009-113570 filed May 8, 2009, which is hereby incorporated by reference herein in its entirety.

What is claimed is:

1. A light-emitting substrate comprising:
a substrate;
a plurality of light-emitting members arranged in a matrix on the substrate; and
a plurality of metal backs arranged in a matrix over the plurality of light-emitting members,
wherein in each row or each column of the plurality of metal backs, two adjacent metal backs are connected to each other through a resistive member; and
a conductive member having a resistance value lower than that of the resistive member is connected to a portion of the resistive member, the portion being spaced from the two adjacent metal backs.

2. The light-emitting substrate according to claim 1, wherein the resistance value of the conductive member is at least one order of magnitude lower than that of the resistive member; and
the conductive member is connected to the resistive member in a direction in which the two adjacent metal backs are arranged, and over a length greater than or equal to a thickness of the resistive member.

3. The light-emitting substrate according to claim 1, wherein the resistive member has a first portion close to one of the two adjacent metal backs, a second portion close to the other of the two adjacent metal backs, and a third portion between the first portion and the second portion; and
the conductive member is connected to the third portion of the resistive member.

4. The light-emitting substrate according to claim 3, wherein a plurality of conductive members are provided; and
the plurality of conductive members are spaced apart and connected to the third portion of the resistive member.

5. The light-emitting substrate according to claim 1, wherein the resistive member has a first portion close to one of the two adjacent metal backs and a second portion close to the other of the two adjacent metal backs; and
the conductive member is disposed between the first portion and the second portion, and connected to both the first portion and the second portion.

6. The light-emitting substrate according to claim 1, wherein a plurality of resistive members that connect the two adjacent metal backs are provided;
a plurality of conductive members are provided; and
the plurality of conductive members and the plurality of resistive members are alternately connected and arranged between the two adjacent metal backs.

7. The light-emitting substrate according to claim 1, further comprising a shielding member disposed between the plurality of light-emitting members,
wherein the resistive member, the conductive member, and the plurality of metal backs are disposed also on the shielding member.

8. The light-emitting substrate according to claim 1, wherein the conductive member is a metal film made of any one of aluminum, copper, titanium, silver, gold, molybdenum, tungsten, tantalum, platinum, and nickel.

9. A display panel comprising:
a light-emitting substrate including a substrate, a plurality of light-emitting members arranged in a matrix on the substrate, and a plurality of metal backs arranged in a matrix over the plurality of light-emitting members; and
a plurality of electron-emitting devices configured to emit electrons to the plurality of light-emitting members,
wherein the light-emitting substrate is the light-emitting substrate according to claim 1.

10. An image display apparatus comprising a display panel, wherein the display panel is the display panel according to claim 9.
